(19) United States
(12) Patent Application Publication
(10) Pub. No.: US 2023/0385682 A1
(43) Pub. Date: Nov. 30, 2023

(54) METHOD AND SYSTEM OF GENERATING A CLASSICAL MODEL TO SIMULATE A QUANTUM COMPUTATIONAL MODEL VIA INPUT PERTURBATION TO ENHANCE EXPLAINABILITY

(71) Applicant: INTERNATIONAL BUSINESS MACHINES CORPORATION, Armonk, NY (US)

(72) Inventors: Vladimir Rastunkov, Mundelein, IL (US); Frederik Frank Flöther, Schlieren (CH); Amol Deshmukh, New York, NY (US); Shikhar Kwatra, San Jose, CA (US)

(21) Appl. No.: 17/825,614

(22) Filed: May 26, 2022

(51) Int. Cl. G06N 10/80; G06N 10/20

(52) U.S. Cl. CPC G06N 10/80; G06N 10/20

(57) ABSTRACT

A method of generating a classical model to simulate a quantum computational model includes 1) inputting into a quantum computational model a dataset, the quantum computational model being implemented on a quantum computer, 2) computing output results with the quantum computational model using the quantum computer, 3) introducing a variation to at least a portion of the dataset into the quantum computer, 4) computing updated output results of the quantum computational model based on the variation of the at least the portion of the dataset using the quantum computer, and 5) generating a classical twin model of the quantum computational model based on a relationship of the output results and updated output results to the dataset from the quantum computational model.

### BACKGROUND

The currently claimed embodiments of the present invention relate to quantum computation, and more specifically, to methods and systems of generating a classical model to simulate a quantum computational model.

With the adoption of machine learning (ML) and artificial intelligence (AI) tools across industries and settings, there has been an increased focus on the explainability and interpretability of such algorithms. There are also debates pertaining to potential mandates for such transparency. Lack of transparency can prevent the realization of benefits that might otherwise be possible with AI tools.

At the same time, quantum computing has continued to make great strides. Such quantum-enhanced applications and workflows will still have many computational steps that are carried out by classical computers. Therefore, addressing the explainability of quantum computational models and quantum-classical workflows is a pressing issue that needs to be addressed as quantum algorithms are finding their way into production systems.

As quantum computing and classical computing become ever more intertwined, the disciplines continue to cross-fertilize. For example, there has been work to leverage quantum concepts in order to enhance the explainability of fully classical pipelines. Prior research work implemented a quantum support vector machine classifier (QSVM) on a superconducting processor. QSVM exploits a high-dimensional quantum Hilbert space to obtain an enhanced solution. This enhancement can be achieved through controlled entanglement and interference, which is inaccessible for classical support vector machines (CSVM). Even though QSVM is the most well-known machine learning model that leverages kernel functions, many other models can be viewed as mathematically related. Due to the quantum mechanical nature of feature spaces and model kernels that further complicate access and ability to examine the model, explainability of quantum machine learning models (QMLs) becomes even more challenging and important. Stakeholders may not only be interested in how the prediction was made, but also in whether the quantum computational model provided advantage or has an equivalent non-quantum computational model. Quantum computational model exploration through simulation of “classical” input data may be computationally intensive for QML due to intermediate “mapping” to quantum states.

### SUMMARY

An aspect of the present invention is to provide a method of generating a classical model to simulate a quantum computational model. The method includes inputting into a quantum computational model a dataset, the quantum computational model being implemented on a quantum computer; computing output results with the quantum computational model using the quantum computer; introducing a variation to at least a portion of the dataset into the quantum computer; computing updated output results of the quantum computational model based on the variation of the at least the portion of the dataset using the quantum computer; and generating a classical twin model of the quantum computational model based on a relationship of the output results and updated output results to the dataset from the quantum computational model.

In an embodiment, the method further includes determining variable importance scores from the classical twin model based on a likelihood of a change in data outcome depending on a change of an input data point. In an embodiment, the method further includes updating the classical twin model based on the variable importance scores. A variable importance score can refer to how much a given model “uses” that variable to make predictions. The more a model relies on a variable to make predictions, the more “important” it is for the model. It can apply to many different models, each using different metrics.

In an embodiment, computing output results with the quantum computational model includes encoding data, processing data, measuring for quantum kernel calculation, and estimating of prediction and cost function.

In an embodiment, quantum information measures are used to inform the development of the classical twin model, including at least one out of a Fisher information spectrum and an effective dimension of the quantum computational model.

In an embodiment, introducing the variation to the at least the portion of the dataset into the quantum computer includes introducing the variation to a broader portion of the dataset and then iteratively narrowing the broader portion of the dataset.

In an embodiment, generating the classical twin model of the quantum computational model based on a relationship of the output results and updated output results to the dataset from the quantum computational model includes generating the classical model by introducing interaction terms between two or more variables in the classical model to simulate entanglement in the quantum computational model.

In an embodiment, the method further includes assessing the twin classical model using a weighted combination of metrics.

In an embodiment, the method further includes determining a chaotic behavior or sensitivity of the updated output results of the quantum computational model based on the variation of the at least the portion of the dataset.

In an embodiment, introducing the variation to the at least the portion of the dataset into the quantum computer includes using a contrastive explainability algorithm.

In an embodiment, computing updated output results of the quantum computational model using the quantum computer includes calculating a variation of an updated output result relative to a variation of a data point selected from the at least portion of the dataset.

In an embodiment, the quantum computational model comprises a computational pipeline having two or more computational steps and at least one quantum computational step and at least one classical step.

In an embodiment, inputting into the quantum computational model the dataset includes inputting into the quantum computational model a classical dataset or a quantum dataset.

Another aspect of the present invention is to provide a system for generating a classical model on a classical computer system to simulate a quantum computational model on a quantum computer. The system includes a quantum computer configured to: receive as input a dataset and run a quantum computational model using the dataset; compute output results with the quantum computational model; receive a variation to at least a portion of the dataset; compute updated output results of the quantum computational model based on the variation of the at least the portion of the dataset. The system also includes a classical computer configured to generate a classical twin model of the quantum computational model based on a relationship of the output results and updated output results to the dataset from the quantum computational model.

In an embodiment, the classical computer is further configured to determine variable importance scores from the classical twin model based on a likelihood of a change in data outcome depending on a change of an input data point.

In an embodiment, the classical computer is further configured to update the classical twin model based on the variable importance scores.

In an embodiment, the quantum computer is further configured to compute output results with the quantum computational model by encoding data, processing data, measuring for quantum kernel calculation, and estimating of prediction and cost function.

In an embodiment, the quantum computer is configured to provide quantum information measures that are used to inform the development of the classical twin model in the classical computer, the quantum information measures including at least one out of a Fisher information spectrum and an effective dimension of the quantum computational model.

In an embodiment, the quantum computer is configured to receive the variation to a broader portion of the dataset and then iteratively narrowing the broader portion of the dataset.

In an embodiment, the classical computer is configured to generate the classical model by introducing interaction terms between two or more variables in the classical model to simulate entanglement in the quantum computational model.

In an embodiment, the classical computer is further configured to assess the twin classical model using a weighted combination of metrics.

In an embodiment, the quantum computer is configured to determine a chaotic behavior or sensitivity of the updated output results of the quantum computational model based on the variation of the at least the portion of the dataset.

In an embodiment, the quantum computer is further configured to use a contrastive explainability algorithm to introduce the variation to the at least the portion of the dataset.

In an embodiment, the quantum computer is configured to calculate a variation of an updated output result relative to a variation of a data point selected from the at least portion of the dataset.

In an embodiment, the quantum computer is configured to receive into the quantum computational model a classical dataset or a quantum dataset.

In this disclosure, a system and method are presented which leverage input perturbation to create a meta-model (classical twin) for a classical-quantum computational model, or more generally a pipeline (workflow), which enables enhanced explainability. A pipeline herein refers to a possibly large number of computational steps that may involve any number of classical and/or quantum computational models.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 is a schematic diagram of a system and method for generating a classical model on a classical computer system to simulate a quantum computational model on a quantum computer, according to an embodiment of the present invention;

FIG. 2 shows a flow diagram showing a process of training a meta-model or quantum computational model and determining variable importance scores, according to an embodiment of the present invention;

FIG. 3 shows an example of dataset (x-direction) that is input into the quantum computer into a quantum computational model defining two “circles” and output results (y-direction), according to an embodiment of the present invention;

FIG. 4 is a schematic representation of a quantum circuit of the model implemented in the quantum computer, according to an embodiment of the present invention;

FIG. 5 is a histogram showing the Quantum Fisher Information (QFI) spectrum in the case where the spectrum is degenerate, according to an embodiment of the present invention;

FIG. 6 is a histogram showing the Quantum Fisher Information (QFI) spectrum in the case where the spectrum is more uniform, according to an embodiment of the present invention; and

FIG. 7 is a plot of a prediction using the quantum computational model highlighting a region around the prediction where perturbed or variation of the input data set is selected, according to an embodiment of the present invention.

### DETAILED DESCRIPTION

As decision support systems across different industries rely on predictive models trained on historical data and complexity of the models increases over time, the issue of explainable artificial intelligence (AI), or XAI, becomes more prominent. More specifically, companies that traditionally emphasized model explainability and relied on “transparent models” like decision trees and logistic regression, for example, financial services and insurance, venture into broader machine learning (ML) space to gain competitive advantage through better model accuracy and performance. By doing so they now need to have tools to explain their “black box” models. On the other end, early adopters of ML models, like retail, telecom, and others are looking into better explainability of their models to avoid bias and improve fairness. Vendors in data science and ML space have introduced a number of solutions to address those concerns.

The concept of “model explainability” has many facets, which, generally, can be viewed as answers to a number of “why” questions that help analysts, auditors and general public to understand models in general and specific predictions in particular. For example, variables or features that have the largest influence on the behavior of the model locally and globally can be investigated. By the term “locally” we assume variable importance at the point of prediction and its vicinity. The term “globally” means aggregated importance on a whole dataset.

In the following paragraphs, a quantum-classical computational pipeline (workflow) is considered. The quantum-classical computational pipeline includes at least one quantum computational model as well as an arbitrary number of additional classical and/or quantum computational steps.

In order to make such a complex quantum computational model/quantum-classical pipeline more explainable, methods of creating a fully classical meta-model (twin model) are described in this disclosure. This fully classical model mimics the behavior of the quantum-classical model, capturing its essential behavior. The quantum-classical model can include purely quantum model steps or a combination of classical model steps and quantum model steps. Prior conventional methods have only been used strictly in the classical context where strategies have been developed to open a classical black-box by deriving a classical transparent model that mimics the original classical black-box, by asking several questions to the opaque box to catch the internal mechanics of its decisions.

On the other hand, embodiments of the present invention take into account aspects unique to quantum computing, as well as the application of the meta-model to understand a pipeline that includes quantum algorithms implemented on a quantum computer. The full behavior of sufficiently complex quantum computational models (e.g., algorithms incorporating quantum circuits) cannot be classically simulated. Therefore, the meta-model captures aspects which are most relevant with regard to understanding the behavior of the full pipeline. For example, there may be cases where even just simulating the key aspects of the full quantum-classical pipeline is beyond purely classical models. In this case, the method may be stopped without achieving a sufficiently good classical twin model.

According to embodiments of the present invention, one aspect is to disturb the input features slightly to derive or extract the importance of features and probe for undesired chaotic behavior. Due to the presence of quantum calculations as well as potentially chaotic behavior of the pipeline, this may be performed repeatedly to accumulate statistics.

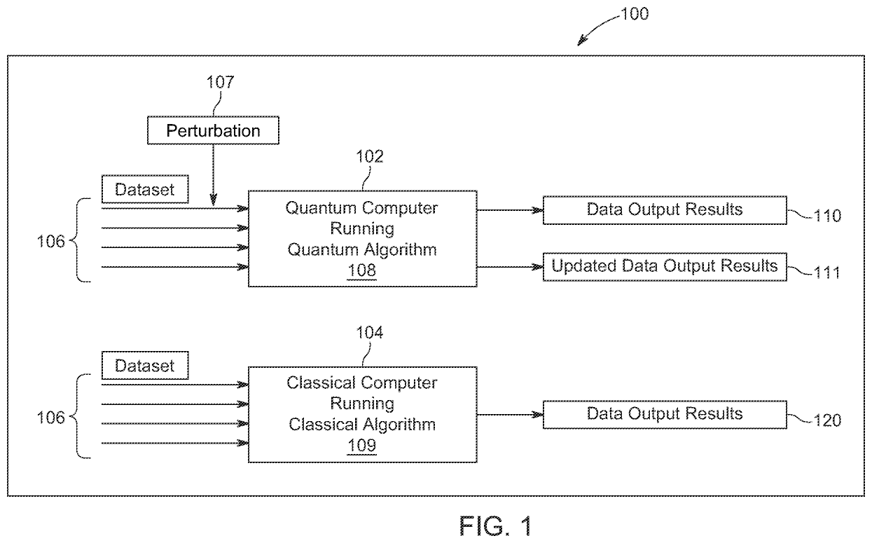

FIG. 1 is a schematic diagram of a system 100 and method for generating a classical model on a classical computer system 104 to simulate a quantum computational model on a quantum computer 102, according to an embodiment of the present invention. The system 100 includes the quantum computer 102 configured to:
1) receive as input a dataset 106 and run a quantum computational model (e.g., a non-transparent quantum computational model) 108 using the dataset 106. The dataset 106 can be, for example, a classical dataset. The classical dataset can be input through a classical computer which can be the same as the classical computer 104 or a different classical computer. The classical dataset is then converted into a quantum compatible dataset to be received as inputs by the quantum computer 102. The dataset 106 can also be a quantum compatible dataset input directly into the quantum computer 102. The quantum computational model 108 can be a transparent quantum computational model or a non-transparent quantum computational model. The term “non-transparent” broadly means that a user does not know the behavior of the quantum computational model 108. The term “non-transparent quantum computational model” can also include a quantum computational model that is partially transparent or at least partially understood. In an embodiment, the quantum computation model 108 can include purely quantum computational steps. In another embodiment, the quantum computational model 108 can include a combination of quantum computational steps and classical computational steps.
2) compute output results 110 with the quantum computational model 108.
3) receive a variation (e.g., perturbation) 107 to at least a portion of the dataset 106.
4) compute updated output results 111 of the quantum computational model based on the variation 107 of the at least the portion of the dataset 106.

In an embodiment, the quantum computer 102 can include a quantum computer having superconducting qubits, e.g., such as Josephson-Junction based transmon qubits.

The system 100 also includes the classical computer 104 configured to generate a classical twin model 109 of the quantum computational model 108 based on a relationship of the output results 120 (corresponding to the output results 110 and updated output results 111) to the dataset 106 from the quantum computational model 108.

In an embodiment, the quantum computational model 108 includes a computational pipeline having two or more computational steps. For example, the quantum computational model 108 can include one or more quantum computational steps and one or more classical computational steps. Similarly, the classical twin model 109 can include one or more classical model, for example two or more classical models.

In an embodiment, the system 100 and method further include determining variable importance score from the classical twin model 109 based on a likelihood of a change in data outcome (updated output results 111) depending on a change of an input data point (i.e., the perturbation 107 to at least a portion of the dataset 106). The variable importance score can be calculated, for example, using the classical twin model 109, as will be further explained in the following paragraphs. The variable importance score can refer to how much the classical twin model 109 “uses” that variable to make predictions. The more the model relies on a variable to make predictions, the more “important” it is for the model.

In an embodiment, the system 100 and method further include updating the classical twin model 109 based on the variable importance scores. In an embodiment, the classical twin model 109 can be updated by changing coefficients of the classical model 109, for example.

An exemplary approach for training a meta-model or quantum computational model 108 and determining variable importance scores, according to an embodiment of the present invention, will now be described. It is noted that, in an embodiment, the description below assumes that the overall quantum-classical pipeline accomplishes a supervised learning task. However, in other embodiments, the method can also be applied more generally to kernel-based models and pipelines as well as other machine learning (ML) or other computational tasks.

In operation, the method may be implemented as follows. A quantum-classical pipeline can be trained given a dataset (e.g., a classical dataset) with a target variable. The target variable can be a continuous output or class labels. The input dataset 106 may have one or many features that can be categorical or continuous. The input dataset 106 can be divided into training and testing subsets. In one implementation, the quantum-classical pipeline may include data encoding, data processing, measurement for quantum kernel calculation, and estimation of prediction and cost function. Data encoding is assumed such that each feature gets encoded in a single qubit.

In an embodiment, computing output results 110 with the quantum computational model includes computing the output results 110 with at least one of a machine learning (ML) algorithm, a neural network, at least a kernel-based estimate. For example, as stated in the above paragraph, a quantum machine learning algorithm (the quantum computational model 108), such as a regression algorithm, for example, can be implemented on the quantum computer 102 where a first subset of the dataset 106 can be used as a training dataset while a second subset of the dataset 106 can be used as a testing dataset. For example, in an embodiment, computing the output results 110 with the quantum machine learning algorithm (the quantum computational model 108), includes applying to the machine learning (ML) algorithm supervised tasks including at least one out of binary classification, multiple classification, and regression. In an embodiment, inputting into the quantum computational model 108 the dataset includes inputting into the quantum computational model 108 training sub-datasets (the first subset of the dataset 106) to train the quantum computational model 108 and testing sub-datasets (the second subset of the dataset 106) to test the quantum computational model 108.

In an embodiment, computing output results 110 with the quantum computational model 108 includes encoding data, processing data, measuring for quantum kernel calculation, and estimating of prediction and cost function.

In an embodiment, inputting into the quantum computational model 108 the dataset 106 includes encoding each data point of the classical dataset 106 into a corresponding single qubit of the quantum computer 102. The single qubit can be then input into the quantum circuit of the quantum computer 102 to interact with other qubits in the circuit through the use of various quantum operators.

A relationship between the input dataset 106, the variation or perturbation 107, the data output results 110, and updated data output results 111 can be used to build a twin classical model 109, acting as a twin of the quantum computational model 108, based on classical machine learning techniques. In an embodiment, quantum information measures can be used to inform the development of the classical twin model 109, including at least one out of calculating a Fisher information spectrum and an effective dimension of the quantum computational model 108. In an embodiment, calculating the Fisher information spectrum includes calculating a distribution of eigenvalues of a Fisher matrix. In an embodiment, a degenerate Fisher spectrum indicates that the quantum computational model 108 is close to the classical twin model 109. In an embodiment, a more uniform Fisher spectrum indicates that the quantum computational model 108 is more complex than the classical twin model 109. When the quantum computational model 108 is more complex than the classical twin model 109, a complexity of the classical twin model 109 is increased by introducing increased inter-relationship between variables of the classical twin model 109 (for example, by changing various coupling parameters in the classical twin model 109). For example, the coupling parameters in the twin classical computational model 109 can simulate the complexity (e.g., level of entanglement of quantum states) of the quantum computational model 108, as will be described further in detail in the following paragraphs.

In an embodiment, if a degenerate calculated Fisher information spectrum is obtained, this indicates that the model is close to “classical” and may be subject to barren plateaus during its training. On the other hand, if an even Fisher information spectrum is obtained, this indicates quantum effects, higher order interactions between input features may be important. In the latter case, a more granular description may be needed in that smaller regions around a selected point of prediction may be needed. In other embodiments, an effective dimension can be used in addition or in place of the quantum Fisher information spectrum. A Fisher information spectrum is a measure of how much information is available about a parameter in a distribution, given samples from the distribution.

In an embodiment, calculating the Fisher information spectrum includes estimating an entanglement of a quantum circuit of the quantum computer 108. In an embodiment, estimating an entanglement of a quantum circuit of the quantum computer includes determining a level of entanglement providing information on interaction terms between variables of the classical model. For example, entanglement of the quantum circuit representing the quantum computational model/algorithm 108 is estimated by the entanglement entropy, negativity or other measures. In an embodiment, the level of entanglement can provide information on the interaction terms between features in a classical twin model 109. For example, in the case of a linear classical model:

$${y}_{i} = {c}_{0} + {\sum }_{j = 0}^{k} {c}_{1 , j} {x}_{i , j} + … + {\sum }_{j} {c}_{l , j} {\underbrace{{\prod }_{s ∈ ( 0 , … , k )} {x}_{i , s}}}_{l \leq k}$$

where k is the number of features and l is the degree of interaction terms. A circuit without entanglement will have only linear terms in the classical twin model represented by the first summation terms in equation (1). Whereas a maximally entangled circuit will also include interaction terms up to the product of all features, represented by the second summation of product terms in equation (1). In an embodiment, the level of interaction can be kept at around 2 to avoid the need for many training samples, for example. However, higher level of interaction greater than 2 can also be used, if desired.

In an embodiment, introducing the variation 107 (e.g., perturbation) to the at least a portion of the dataset 106 into the quantum computer 102 includes introducing the variation 107 (e.g., perturbation) to a broader portion of the dataset 106 and then iteratively narrowing the broader portion of the dataset 106. For example, in an embodiment, a quantum-classical pipeline 108 is used to build a prediction \tilde{y}=f(x₁, x₂, . . . ). A small region around a desired prediction point is selected (x₁±Δx₁, x₂±Δx₂, . . . ). That is, a certain range or region (portion) within the dataset 106 is selected. Continuous variables such as a small region can be selected through iterations starting with a broader region within the dataset 106 and then narrowing down the region in the dataset 106.

In an embodiment, computing updated output results 111 of the quantum computational model 108 using the quantum computer 102 includes introducing perturbations 107 by switching a value of a variable of the quantum computational model. For ordinal features, the value is increased/decreased in small increments. For implementations of binary variables, this can imply flipping the value of the variable. For implementations with columns with high cardinality, this can be one-hot encoded. In an embodiment, the data from this region can be used to build predictions \tilde{y}=f(x₁±Δx₁, x₂±Δx₂, . . . ) and form a new dataset (xᵢ, \tilde{y}ᵢ) (corresponding to the updated data output results 111). In an embodiment, adversarial examples may be flagged and stored.

In an embodiment, computing updated output results 111 of the quantum computational model 108 using the quantum computer 102 includes calculating a variation of an updated output result 111 relative to a variation of a data point selected from the at least portion of the dataset 106.

In an embodiment, generating the classical twin model 109 of the quantum computational model 108 based on a relationship of the output results 110 and updated output results 111 to the dataset 106 from the quantum computational model 108 includes generating the classical model 109 by introducing interaction terms between two or more variables in the classical model to simulate entanglement in the quantum computational model. In an embodiment, introducing the interaction terms between two or more variables in the classical model 109 to simulate entanglement in the quantum computational model 108 includes introducing product terms in a non-linear implementation of the twin classical model, as described in the above paragraphs with respect to, for example, equation (1) in the case of a linear classical model.

In an embodiment, the method and system 100 further includes assessing the twin classical model 109 using a weighted combination of metrics. For example, there is a range of enabling art around (quantitatively) assessing explainability. In an embodiment, a weighted combination of multiple parameters may be considered. These parameters include, but are not limited to, at least one of the following:
a) Accuracy with which test cases that are run through the full pipeline are reproduced (e.g., higher accuracy is better)
b) Number of features (e.g., fewer are better)
c) Complexity of feature terms (e.g., independent uncorrelated feature terms are better)
d) Chaotic behavior (e.g., the less sensitive the twin model is to small changes in input values, the better)
e) Running time to get an output from the classical twin model (e.g., faster is better) Thus, one can see that a diverse range of parameters need to be considered when assessing how explainable/transparent a given model or computational pipeline is. This assessment is not black and white. For instance, a model with many simple features and a model with few but very complex features might both be considered to have medium explainability.

In an embodiment, the classical twin model 109 is used to produce variable importance scores. In one embodiment, the classical model 109 is “transparent” and can be directly used to calculate scores. In other embodiment, the classical model 109 can be further simplified, e.g., by taking only the top features.

In an embodiment, the method and system 100 further includes determining a chaotic behavior or sensitivity of the updated output results 111 of the quantum computational model 108 based on the variation (e.g., perturbation) of the at least the portion 107 of the dataset 106.

In an embodiment, the method and system 100 further includes altering parameters of the classical twin model 109 based on the updated output results 111 of the quantum computational model 108 and associated at least the portion of the classical dataset 107. In an embodiment, introducing the variation (e.g., perturbation) to the at least the portion 107 of the dataset 106 into the quantum computer 108 includes using a contrastive explainability algorithm.

In an embodiment, computing the output results 110 with the quantum computational model 108 using the quantum computer 102 includes computing the output results 110 using a quantum machine learning algorithm (ML) and detecting outlier output results in the output results 110. In an embodiment, computing the output results 110 with the quantum computational model 108 using the quantum computer 102 includes predicting output results 110 based on base query metric values and outlier output results in the output results 110. In an embodiment, introducing the variation to the at least the portion of the dataset 106 includes introducing a perturbation 107 to the at least the portion of the dataset 106 anywhere within a quantum circuit of the quantum computer 102.

In an embodiment, the method and system 100 includes repeating selecting the region within the dataset and introducing perturbations and using the data from the region to build the prediction predictions \tilde{y}=f(x₁±Δx₁, x₂±Δx₂, . . . ) and to form the new dataset (xᵢ, \tilde{y}ᵢ). Data from the repeating the selecting and using the data from the region is used to train the classical twin model 109. The performance of the twin model is assessed through a combination of metrics. The classical twin model is used to produce variable importance scores. The repeating of the selecting the region within the dataset and introducing perturbations and using the data from the region to build the prediction predictions \tilde{y}=f(x₁±Δx₁, x₂±Δx₂, . . . ) and to form the new dataset (xᵢ, \tilde{y}ᵢ) is performed until the following conditions are met:
a) A threshold in the metrics used to assess the twin model has been exceeded
b) A threshold amount of time has been exceeded (the threshold amount of time can be for example set by the user)
c) A threshold number of iterations has been exceeded (the number of iterations can be set by the user)
d) A threshold in computational cost of the workflow (e.g., number of executions on real quantum hardware) has been exceeded

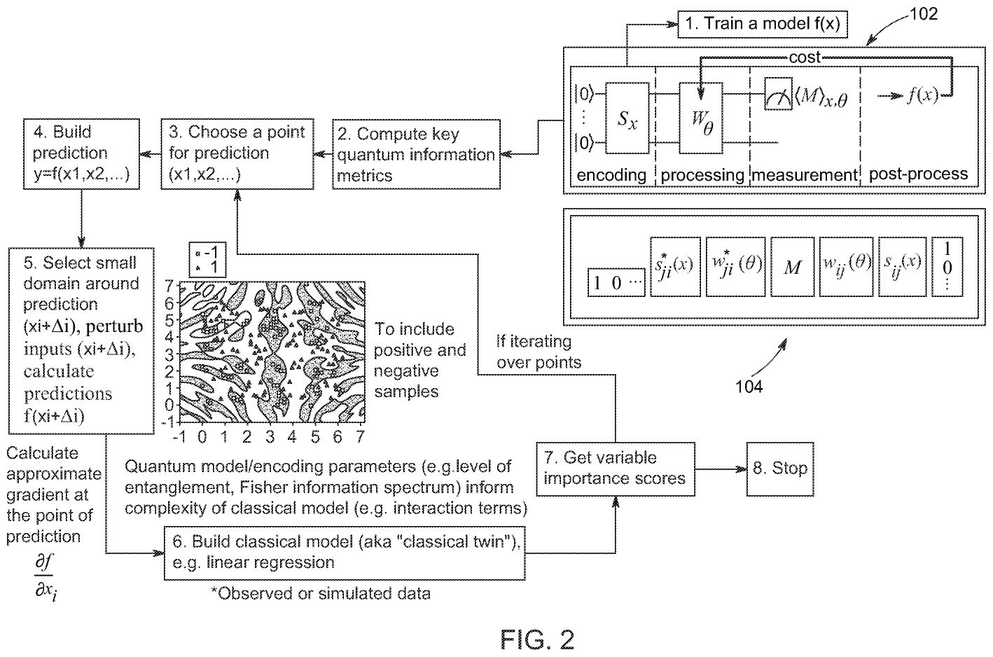

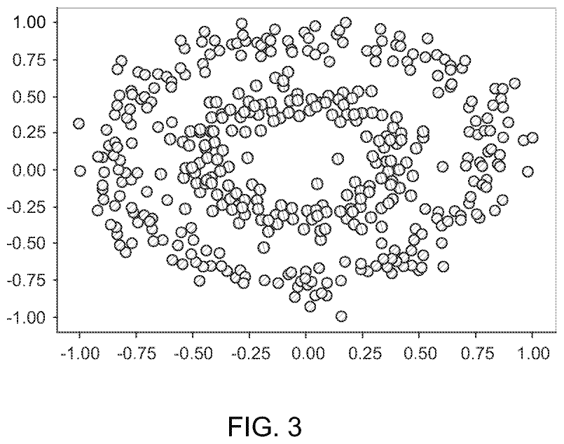

FIG. 2 is a flow diagram showing a method for training the quantum computational model 108 and determining variable importance scores, according to an embodiment of the present invention. The numbering below corresponds to the numbering used FIG. 2. The example described herein, with respect to FIG. 2, further explains and provides additional details of the method and system 100, shown in FIG. 1 and described in the above paragraphs. In an embodiment, the method and system 100 implements the following steps:
1. A quantum-classical pipeline can be trained given a classical dataset with a target variable. The target variable can be a continuous output or includes class labels. The input data may have one or many features that can be categorical or continuous. The data is divided into training and testing subsets. In a particular implementation, the quantum-classical pipeline may follow and include data encoding, data processing, measurement for quantum kernel calculation, and estimation of prediction and cost function. Data encoding is assumed such that each feature gets encoded in a single qubit.
2. Key quantum information metrics are computed. For example, the pipeline's Fisher information spectrum can be calculated. A degenerate spectrum indicates that the model is close to “classical” and may be subject to barren plateaus during its training, while an even spectrum indicates quantum effects, higher order interactions between input features are important. In the latter case, a more granular description is required (i.e., smaller regions around selected point of prediction). In certain implementations, an effective dimension can be used in addition or in place of the quantum Fisher information spectrum. Entanglement of the quantum circuit is estimated by the entanglement entropy negativity or other measures. For example, the level of entanglement can provide information on the interaction terms between features in a classical “twin” model. For example, in the case of a linear classical model, equation (1) can be used.
3. The point(s) of prediction is/are selected. The point of predictions are selected by selecting input dataset 106 (x₁, x₂, . . . ). For example, a desired prediction point can be selected within a range such as (x₁±Δx₁, x₂±Δx₂, . . . ). That is, a certain range or region (portion) within the dataset 106 is selected (see, for example, FIG. 3).
4. The quantum-classical pipeline is used to build a prediction \tilde{y}=f(x₁, x₂, . . . ) based on the input dataset (x₁, x₂, . . . ).
5. A small region around the prediction point is selected (x₁±Δx₁, x₂±Δx₂, . . . ). For continuous variables such a small region can be selected through iterations starting broad and narrowing down. For categorical features, the perturbations are introduced by switching the level of the variable (x₁, x₂, etc.). For ordinal features, the variable (for example, x₁ or x₂, etc.) is increased/decreased in small steps. For implementations of binary variables, this could mean flipping the value of the variable. For implementations with columns with high cardinality, this can be one-hot encoded. The data from this region is used to build predictions \tilde{y}=f(x₁±Δx₁, x₂±Δx₂, . . . ) and form a new dataset (xᵢ, \tilde{y}ᵢ). Optionally, adversarial examples may be flagged and stored. Note that the method not only generates a meta-model but also enables adversarial examples to be discovered. These are examples which are designed so that the quantum-classical pipeline and/or the meta-model provide an erroneous output, e.g., due to a lack of robustness (small change in input data yields a very different output). It may not be possible to alter the actual pipeline to address such often undesirable behavior directly. As the classical twin model 109 is created, however, some such adversarial examples for the meta-model can be addressed by updating the twin model. However, it might not be possible to address all such cases for the twin model, given that the twin model only represents a simplified view of the full pipeline. Moreover, it may not always be desirable to address such cases in the twin model as the twin model is then deliberately engineered to differ from the pipeline. Therefore, a computational analysis can first be carried out, by checking further points in the vicinity, if the detected adversarial example represents a “real” part of the pipeline (e.g., a phase transition) or a random aberration. If it is an aberration, the twin model may be smoothed/corrected and the adversarial example is stored so that it can be further inspected/analyzed as may be needed.
6. The data from previous step is used to train a classical (“twin”) model. The shape of the twin model is informed by step 2 above. That is the shape or the selection of parameters or importance of variable in the classical twin model 109 is determined depending on the results obtained when performing the Fisher Spectrum analysis, as will be explained further below with reference to an example. The performance of the twin classical model 109 is assessed through a combination of metrics. In an embodiment, a weighted combination of multiple parameters is considered. The weighted parameters may include, for example, the accuracy with which test cases that are run through the full pipeline are reproduced (higher accuracy is better). In one implementation, the test cases can be randomly generated. In another implementation, the input-output landscape of the pipeline is first mapped at a coarse level by trying various inputs (or through prior knowledge) and the test cases are then selected so that they are more densely spread in regions of interest (e.g., phase transitions). The weighted parameters may also be based on the number of features (fewer are better) and/or complexity of feature terms in the twin classical model 109 (independent uncorrelated feature terms are better). The weighted parameters may also be based on a chaotic behavior (the less sensitive the twin model is to small changes in input values, the better). The weighted parameters may further be based on running time to get an output from the classical twin model (faster is better).
7. The classical twin model is used to produce variable importance scores. In one implementation, the classical twin model 109 is “transparent” and can be directly used to calculate the variable importance scores. In other cases, it can be further simplified, e.g., by taking only the top features.
8. Steps 3 through 7 are repeated (if the pipeline itself is modified, step 2 may also be repeated) until one or more of the following conditions is met: a) threshold in the metrics used to assess the twin model has been exceeded (success), b) threshold amount of time has been exceeded (failure), c) threshold number of iterations has been exceeded (failure), d) A threshold in computational cost of the workflow (e.g., number of executions on real quantum hardware) has been exceeded (failure)

As it can be appreciated from the above paragraphs, the building of the classical twin model 109 takes into account information that is unique to quantum computing, e.g., entanglement and the quantum Fisher information, for example. Running a complex quantum computational model/circuit an arbitrary number of times is not possible due to limited hardware access. Therefore, the method described herein above includes stopping criteria to take this into account and can be designed to avoid having to run the quantum algorithms too many times. Quantum-classical pipelines are often more complex than purely classical ones. Therefore, the quantum-classical pipelines may exhibit (classical) chaotic behavior in certain regimes, in addition to the inherent quantum uncertainty. This implies that any single output can be rather misrepresentative and therefore statistics may need to be collected.

In the following paragraphs, a specific example is provided using the method and system 110 described in the above paragraphs. We assume the quantum-classical pipeline is constructed to classify “circles” dataset, which has two features and two classes as shown in FIG. 3. The “circles” or “ovals” are shown as clusters of data points defining circumferences in FIG. 3. FIG. 3 shows an example of dataset 106 (x-direction) that is input into the quantum computer 102 in the quantum computational model 108 defining two “circles” and output results 110 (y-direction), according to an embodiment of the present invention. Using the couple dataset (x, y), the “circles” can be constructed.

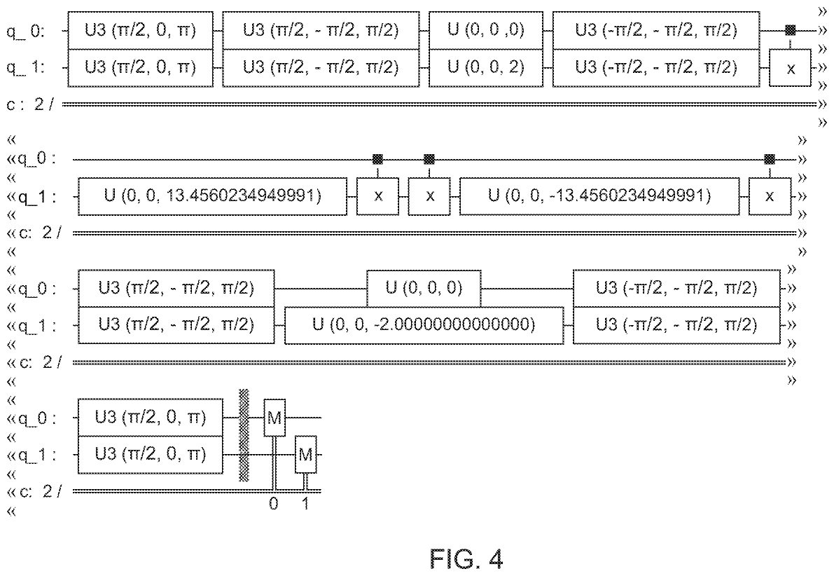

FIG. 4 is a schematic representation of a quantum circuit of the model 108 implemented in the quantum computer 102, according to an embodiment of the present invention. It is assumed that the quantum part of the pipeline, quantum kernel, has a Pauli map with the following parameters alpha=2, reps=1, paulis=[‘Y’, ‘ZZ’]. The circuit shown in FIG. 4 has entanglement and interaction terms between variables by the Pauli feature map and visual assessment.

In an embodiment, a goal is to be able to explain this model 108 (as a part of the pipeline) in terms of feature importance for specific prediction. Therefore, the requirements with quantum information metrics are:
1. define the form of the classical twin model 109 and, specifically, the need for interaction terms. It is noted that the form of the classical twin model 109 informs the amount of data needed to simulate by perturbing the inputs and run the data 106 through the quantum computer 102.
2. Use metrics to assess the quality of quantum computational model 108 and identify the need to update it.

Calculation and Application of Quantum Information Metrics. A universal measure of entanglement is still an active area of research. In the above paragraphs, we have suggested entanglement entropy and negativity measures as candidates for a particular implementation. Since in the present example we have only two qubits, we can leverage entanglement entropy, as an example.

If the entanglement entropy is 0, then the system is separable and can be simulated classically. Specifically, the recommendation in the present method is to include only main effects into the classical twin. We stated the assumption that variables are encoded on different qubits. If the system is maximally entangled, then it is most difficult to simulate classically and may run into risk of entanglement induced barren plateaus. The recommendation in the present method suggests using main effects as well as interactions in the classical twin model and iterate, reducing the region around the point of prediction, if the classical twin performance is not satisfactory as defined by the stopping criteria. Separate recommendation to the user is to test the quantum computational model 108 with less entanglement to avoid issues. If the system is between not-entangled and maximally-entangled, we identify empirically cutoffs for the values of this measure to trigger an increase in complexity of the classical twin model.

Quantum Fisher Information (QFI) spectrum: This measure uses parameterized quantum circuit to be available in order to calculate the QFI spectrum. In one implementation, one needs to make this conversion from the final quantum computational model back to parameterized circuit that is used in variational algorithm. Then, the QFI spectrum is calculated as distribution of eigenvalues of the Fisher matrix.

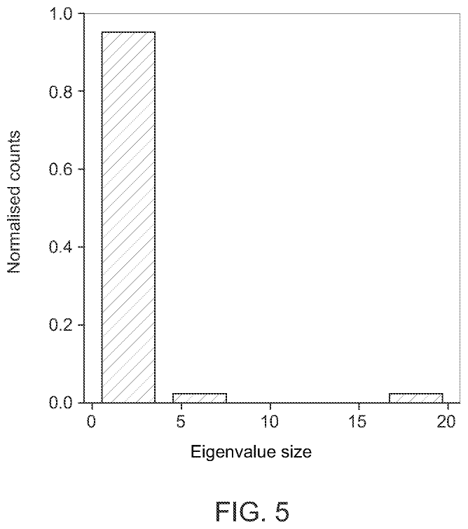

FIG. 5 is a histogram showing the QFI spectrum in the case where the spectrum is degenerate, according to an embodiment of the present invention. The QFI spectrum is degenerate in this case where all counts are found within a specific eigenvalue of the Fisher matrix. This implies that the quantum computational model 108 is close to the classical model 109. In this case, the present described method recommends a simpler classical twin model without interaction terms.

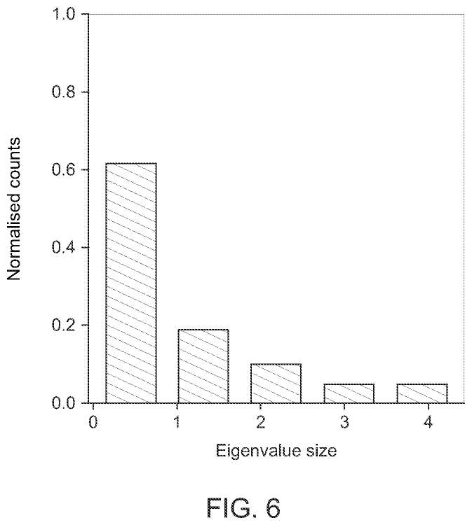

FIG. 6 is a histogram showing the QFI spectrum in the case where the spectrum is more uniform, according to an embodiment of the present invention. The QFI spectrum is more uniform in this case where all counts are spread among eigenvalues of the Fisher matrix. If the spectrum is more uniform, then the quantum computation model 108 has more “power” in that there is more entanglement present between the quantum states. Therefore, the present described method recommends using a more complex classical twin computational model 109 by introducing interaction terms, as described above with respect to equation (1). For example, in one implementation, one can use a specific cutoff between degenerate and uniform. The X-axis represents the eigenvalue size and Y-axis represents the normalized counts.

Based on quantum information metrics (e.g., in this case the QFI spectrum) discussed above, the recommendation of the classical twin complexity is made, which, in turn, converts into recommendation about the amount of data to be simulated. Separately, a recommendation to re-train the quantum computational model 108 or switch to the classical model 109 can be made in certain scenarios.

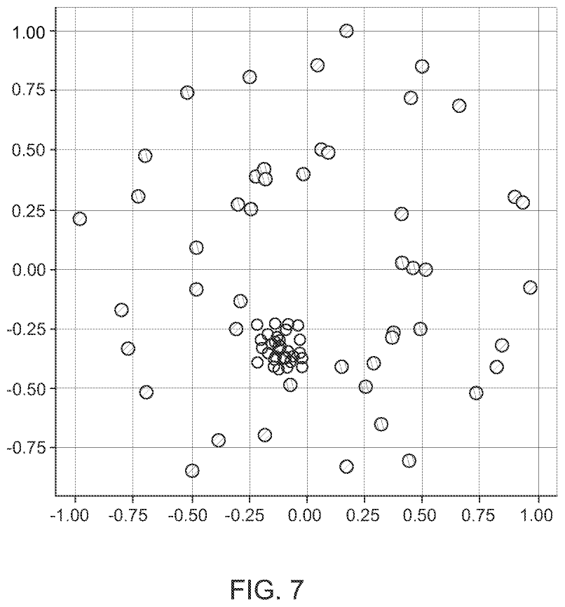

FIG. 7 is a plot of a prediction using the quantum computational model 108 highlighting a region around the prediction where perturbed or variation of the input data set is selected, according to an embodiment of the present invention. The open circle points correspond to the region around the prediction where perturbed data points are simulated. The twin classical computational model 109 based on logistic regression in this example is trained with interactions between variables x1, x2 included. Specifically, coefficient for x₁, x₂, and product x₁*x₂ are determined, based on equation (1). In the present example, coefficient for x₁ is 0.37650065, coefficient for x₂ is 0.2526287, and coefficient for the product x₁*x₂ is −0.1495627. These coefficients provide the relative size of the effects and direction. The presence of a non-zero coefficient for the product x₁*x₂ indicates the presence of entanglement of quantum states in the corresponding quantum computation in the quantum computational model 108.

Generally, to interact with a quantum computer, a classical computer is used. The classical or conventional computer provides inputs and receives outputs from the quantum computer. The inputs may include instructions included as part of the code and data inputs. The outputs may include quantum data results of a computation of the code on the quantum computer 102. In the present case, the classical computer that may be used to interact with the quantum computer 102 can be the classical computer 104 or a different classical computer.

The classical computer interfaces with the quantum computer via a quantum computer input interface and a quantum computer output interface. The classical computer sends commands or instructions included within the code or data inputs to the quantum computer system via the input and the quantum computer returns outputs results of the quantum computation of the code to the classical computer via the output. The classical computer can communicate with the quantum computer wirelessly or via the internet. In an embodiment, the quantum computer 102 can be a superconducting quantum computer or other quantum computer. In an embodiment, the quantum computer can also be a quantum computer simulator simulated on a classical computer. For example, the quantum computer simulating the quantum computing simulator can be one and the same as the classical computer. In an embodiment, the quantum computer is a superconducting quantum computer including one or more quantum circuits (Q chips), each quantum circuit comprises a plurality of qubits, one or more quantum gates, entanglement gates, measurement devices, etc.

In an embodiment, the code may be stored in a computer program product which include a computer readable medium or storage medium or media. Examples of suitable storage medium or media include any type of disk including floppy disks, optical disks, DVDs, CD ROMs, magnetic optical disks, RAMS, EPROMs, EEPROMs, magnetic or optical cards, hard disk, flash card (e.g., a USB flash card), PCMCIA memory card, smart card, or other media. In another embodiment, the code can be downloaded from a remote conventional or classical computer or server via a network such as the internet, an ATM network, a wide area network (WAN) or a local area network. In yet another embodiment, the code can reside in the “cloud” on a server platform, for example. In some embodiments, the code can be embodied as program products in the conventional or classical computer such as a personal computer or server or in a distributed computing environment comprising a plurality of computers that interacts with the quantum computer by sending instructions to and receiving data from the quantum computer.

The code may be stored as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” or “code” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A method of generating a classical model to simulate a quantum computational model, the method comprising;
inputting into a quantum computational model a dataset, the quantum computational model being implemented on a quantum computer;
computing output results with the quantum computational model using the quantum computer;
introducing a variation to at least a portion of the dataset into the quantum computer;
computing updated output results of the quantum computational model based on the variation of the at least the portion of the dataset using the quantum computer; and
generating a classical twin model of the quantum computational model based on a relationship of the output results and the updated output results to the dataset from the quantum computational model.

2. The method according to claim 1, further comprising determining variable importance scores from the classical twin model based on a likelihood of a change in data outcome depending on a change of an input data point.

3. The method according to claim 2, further comprising updating the classical twin model based on the variable importance scores.

4. The method according to claim 1, wherein computing output results with the quantum computational model using the quantum computer comprises encoding data, processing data, measuring for quantum kernel calculation, and estimating of prediction and cost function.

5. The method according to claim 1, wherein quantum information measures are used to inform the development of the classical twin model, the quantum information measures including at least one out of a Fisher information spectrum and an effective dimension of the quantum computational model.

6. The method according to claim 1, wherein introducing the variation to the at least the portion of the dataset into the quantum computer comprises introducing the variation to a broader portion of the dataset and then iteratively narrowing the broader portion of the dataset.

7. The method according to claim 1, wherein generating the classical twin model of the quantum computational model based on a relationship of the output results and updated output results to the dataset from the quantum computational model comprises generating the classical model by introducing interaction terms between two or more variables in the classical model to simulate entanglement in the quantum computational model.

8. The method according to claim 1, further comprising assessing the twin classical model using a weighted combination of metrics.

9. The method according to claim 1, further comprising determining a chaotic behavior or sensitivity of the updated output results of the quantum computational model based on the variation of the at least the portion of the dataset.

10. The method according to claim 1, wherein introducing the variation to the at least the portion of the dataset into the quantum computer comprises using a contrastive explainability algorithm.

11. The method according to claim 1, wherein computing updated output results of the quantum computational model using the quantum computer comprises calculating a variation of an updated output result relative to a variation of a data point selected from the at least portion of the dataset.

12. The method according to claim 1, wherein the quantum computational model comprises a computational pipeline having two or more computational steps, and at least one quantum computational step and at least one classical step.

13. The method according to claim 1, wherein inputting into the quantum computational model the dataset comprises inputting into the quantum computational model a classical dataset or a quantum dataset.

14. A system for generating a classical model on a classical computer system to simulate a quantum computational model on a quantum computer, the system comprising:
a quantum computer configured to:
receive as input a dataset and run a quantum computational model using the dataset;
compute output results with the quantum computational model;
receive a variation to at least a portion of the dataset;
compute updated output results of the quantum computational model based on the variation of the at least the portion of the dataset; and
a classical computer configured to:
generate a classical twin model of the quantum computational model based on a relationship of the output results and updated output results to the dataset from the quantum computational model.

15. The system according to claim 14, wherein the classical computer is further configured to determine variable importance scores from the classical twin model based on a likelihood of a change in data outcome depending on a change of an input data point.

16. The system according to claim 15, wherein the classical computer is further configured to update the classical twin model based on the variable importance scores.

17. The system according to claim 14, wherein the quantum computer is further configured to compute output results with the quantum computational model by encoding data, processing data, measuring for quantum kernel calculation, and estimating of prediction and cost function.

18. The system according to claim 14, wherein the quantum computer is configured to provide quantum information measures that are used to inform the development of the classical twin model in the classical computer, the quantum information measures including at least one out of a Fisher information spectrum and an effective dimension of the quantum computational model.

19. The system according to claim 14, wherein the quantum computer is configured to receive the variation to a broader portion of the dataset and then iteratively narrowing the broader portion of the dataset.

20. The system according to claim 14, wherein the classical computer is configured to generate the classical model by introducing interaction terms between two or more variables in the classical model to simulate entanglement in the quantum computational model.

21. The system according to claim 14, wherein the classical computer is further configured to assess the twin classical model using a weighted combination of metrics.

22. The system according to claim 14, wherein the quantum computer is configured to determine a chaotic behavior or sensitivity of the updated output results of the quantum computational model based on the variation of the at least the portion of the dataset.

23. The system according to claim 14, wherein the quantum computer is further configured to use a contrastive explainability algorithm to introduce the variation to the at least the portion of the dataset.

24. The system according to claim 14, wherein the quantum computer is configured to calculate a variation of an updated output result relative to a variation of a data point selected from the at least portion of the dataset.

25. The system according to claim 14, wherein the quantum computer is configured to receive into the quantum computational model a classical dataset or a quantum dataset.
